(19) United States
(12) Patent Application Publication
(10) Pub. No.: US 2022/0027793 A1
(43) Pub. Date: Jan. 27, 2022

(54) DEDICATED ARTIFICIAL INTELLIGENCE SYSTEM

(71) Applicant: UNIONPLACE CO., LTD., Seoul (KR)

(72) Inventor: Seongcheol BANG, Seoul (KR)

(73) Assignee: UNIONPLACE CO., LTD., Seoul (KR)

(21) Appl. No.: 17/497,752

(22) Filed: Oct. 8, 2021

Related U.S. Application Data
(63) Continuation of application No. PCT/KR2020/013457, filed on Oct. 5, 2020.

(30) Foreign Application Priority Data
Dec. 19, 2019 (KR) 10-2019-0170334

(51) Int. Cl. G06N 20/00; G06F 16/903

(52) U.S. Cl. CPC G06N 20/00; G06F 16/90335

(57) ABSTRACT

A dedicated artificial intelligence system for enterprise business process is provided. The dedicated artificial intelligence system includes a communication interface and an operation processor performing: (a) receiving an information input transmitted from the computer system through the communication interface; (b) generating a first information output from the information input by using an artificial intelligence model; (c) generating external query information based on the information input; (d) transmitting the external query information to each of one or more external artificial intelligence systems through the communication interface; (e) receiving one or more second information outputs respectively transmitted from the one or more external artificial intelligence systems through the communication interface; (f) generating a third information output by comparing the first information output and the one or more second information outputs using the artificial intelligence model; and (g) transmitting the third information output to the computer system through the communication interface.

### CROSS-REFERENCE TO RELATED PATENT APPLICATION

This application is a bypass continuation of International Application No. PCT/KR2020/013457 filed on Oct. 5, 2020 in the WIPO, and Korean Patent Application No. 10-2019-0170334 filed on Dec. 19, 2019 in the Korean Intellectual Property Office, the entire contents of which are hereby incorporated by reference.

### BACKGROUND

### 1. Field

The present disclosure relates to a dedicated artificial intelligence system, and more particularly, to a dedicated artificial intelligence system capable of increasing a learning speed by using an information output of an external artificial intelligence system while enhancing security.

This work was supported by Institute of Information & communications Technology Planning & Evaluation (IITP) grant funded by the Korea government (MSIT) (No. 2021-0-00468, NIST unique number 1711134791, “Implementation WEB, APP Publishing AI assist Platform Based AI Inference Engine”).

### 2. Description of the Related Art

Artificial intelligence refers to a field of computer science and information technology that studies how computers can perform processes such as thinking and learning that were performed through human intelligence. An artificial intelligence model, such as a deep learning algorithm, may be used to implement the artificial intelligence. For example, an artificial intelligence model based on a deep learning algorithm is trained using training data.

For example, Korean Patent Application Publication No. 10-2019-0110500 (Patent Document 1) entitled “Artificial Intelligence Server”, filed by LG Electronics Co., Ltd. and published on Sep. 30, 2019, discloses an artificial intelligence server that can improve the performance of an artificial intelligence model by training the artificial intelligence model to be domain adaptation to the various domains that caused an incorrect answer.

In addition, Korean Patent Application Publication No. 10-2019-0107626 (Patent Document 2) entitled “Artificial Intelligence Server”, filed by LG Electronics Co., Ltd. and published on Sep. 20, 2019, discloses an artificial intelligence server that may receive personalized information from a user requested recognition and perform personalized recognition using the received personalized information to save a storage space of the server and provide a personalized recognition service.

In addition, Korean Patent Application Publication No. 10-2019-0106861 (Patent Document 3) entitled “Artificial Intelligence Server”, filed by LG Electronics Co., Ltd. and published on Sep. 20, 2019, discloses an artificial intelligence apparatus for determining whether data is suitable for a learning of a target artificial intelligence model among data collected in a real environment and adding labeling data to the data suitable for the learning to generate training data, an artificial intelligence server, and a method for the same.

Meanwhile, an enterprise computer system (corporate computer system), for example, a computer system such as a customer relationship management (CRM) system, a fraud detection system and a factory management system mainly performs business processes based on rules. If artificial intelligence is applied to the enterprise computer system, it is possible to perform and control business processes more efficiently.

The following methods can be considered when constructing an enterprise business environment (corporate working environment) by applying the artificial intelligence to the enterprise computer system (corporate computer system).

First, a method of connecting an external artificial intelligence system and the enterprise computer system may be considered. The external artificial intelligence system is also referred to as “an artificial intelligence platform” and may be provided by information and communication companies such as Google and Amazon. By connecting the external artificial intelligence system and the enterprise computer system, it is possible to build a business (working) environment with artificial intelligence applied at a simple and relatively low cost. However, in this method, the company's sensitive information is transferred to the external artificial intelligence system. Therefore, the sensitive information such as company's trade secret information, customer's personal information and device identification information may be exposed to the outside.

Secondly, a method of connecting a dedicated artificial intelligence system for use in the enterprise and the enterprise computer system may be considered. By connecting the dedicated artificial intelligence system for use in the enterprise and the enterprise computer system, it is possible to prevent the company's sensitive information from being exposed to the outside. However, the performance of the dedicated artificial intelligence system is generally lower than that of the external artificial intelligence system, and the learning speed of the dedicated artificial intelligence system is lower than that of the external artificial intelligence system. Therefore, it takes time to improve the performance of the dedicated artificial intelligence system up to a level that can be applied to the actual business or work. Since the performance of the artificial intelligence system is determined depending on the learning speed of the artificial intelligence system, the performance of the dedicated artificial intelligence system is often relatively and significantly lower than the performance of the external artificial intelligence system.

### RELATED ART DOCUMENT

### Patent Document

Patent Document 1: Korean Patent Application Publication No. 10-2019-0110500

Patent Document 2: Korean Patent Application Publication No. 10-2019-0107626

Patent Document 3: Korean Patent Application Publication No. 10-2019-0106861

### SUMMARY

In view of the above, the present disclosure provides a dedicated artificial intelligence system capable of increasing a learning speed by using an information output of an external artificial intelligence system (or external artificial intelligence systems) while enhancing security.

In accordance with an aspect of the present disclosure, there is provided a dedicated artificial intelligence system connected to a computer system that performs enterprise business processes, the dedicated artificial intelligence system comprising: a communication interface; and an operation processor connected to the communication interface, the operation processor performing: (a) receiving information input transmitted from the computer system through the communication interface; (b) generating a first information output from the information input by using an artificial intelligence model; (c) generating external query information based on the information input; (d) transmitting the external query information to each of one or more external artificial intelligence systems through the communication interface; (e) receiving one or more second information outputs respectively transmitted from the one or more external artificial intelligence systems through the communication interface; (f) generating a third information output by comparing the first information output and the one or more second information outputs using the artificial intelligence model; and (g) transmitting the third information output to the computer system through the communication interface.

### BRIEF DESCRIPTION OF THE DRAWINGS

FIG. 1 is a diagram illustrating an exemplary configuration of a dedicated artificial intelligence system according to a first embodiment of the present disclosure.

FIG. 2 is a diagram illustrating an exemplary configuration of a system environment including the dedicated artificial intelligence system according to the first embodiment of the present disclosure.

FIG. 3 is a diagram illustrating an example of processes performed by an operation processor of the dedicated artificial intelligence system according to the first embodiment.

FIG. 4 is a diagram specifically illustrating a process of generating first information output by the operation processor of the dedicated artificial intelligence system according to the first embodiment.

FIG. 5 is a diagram specifically illustrating the process in which the operation processor of the dedicated artificial intelligence system according to the first embodiment generates the first information output.

FIGS. 6A and 6B are diagrams specifically illustrating a process of generating external query information by the operation processor of the dedicated artificial intelligence system according to the first embodiment.

FIGS. 7A and 7B are diagrams specifically illustrating a process of generating third information output by the operation processor of the dedicated artificial intelligence system according to the first embodiment.

FIG. 8 is a diagram illustrating an exemplary configuration of a dedicated artificial intelligence system according to a second embodiment of the present disclosure.

FIG. 9 is a diagram illustrating an exemplary configuration of a system environment including the dedicated artificial intelligence system according to the second embodiment of the present disclosure.

FIG. 10 is a diagram illustrating an example of processes performed by an interface device according to the second embodiment of the present disclosure.

### DETAILED DESCRIPTION

Hereinafter, an embodiment of a dedicated artificial intelligence system according to a technique described in the present disclosure will be described in detail with reference to the accompanying drawings. Meanwhile, in the drawings for describing the embodiments of the techniques of the present disclosure, for the sake of convenience of description, only a part of the practical configurations may be illustrated or the practical configurations may be illustrated while a part of the practical configurations is omitted or changed. Further, relative dimensions and proportions of parts therein may be exaggerated or reduced in size.

### First Embodiment

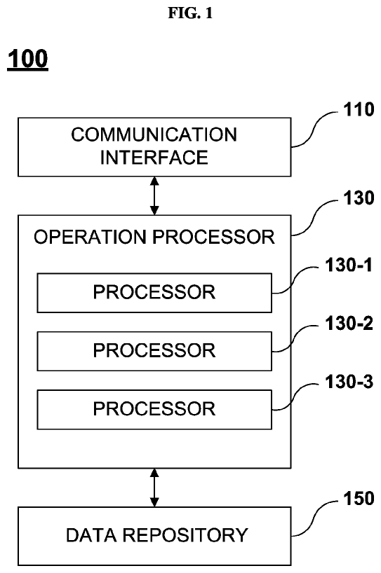

FIG. 1 is a diagram illustrating an exemplary configuration of a dedicated artificial intelligence system according to a first embodiment of the present disclosure.

Referring to FIG. 1, the dedicated artificial intelligence system 100 includes a communication interface 110 and an operation processor 130. Further, referring to FIG. 1, the dedicated artificial intelligence system 100 may further include a data repository 150.

The dedicated artificial intelligence system 100 according to the technique described in the present disclosure may be implemented using, for example, computing devices such as personal computers and dedicated computers.

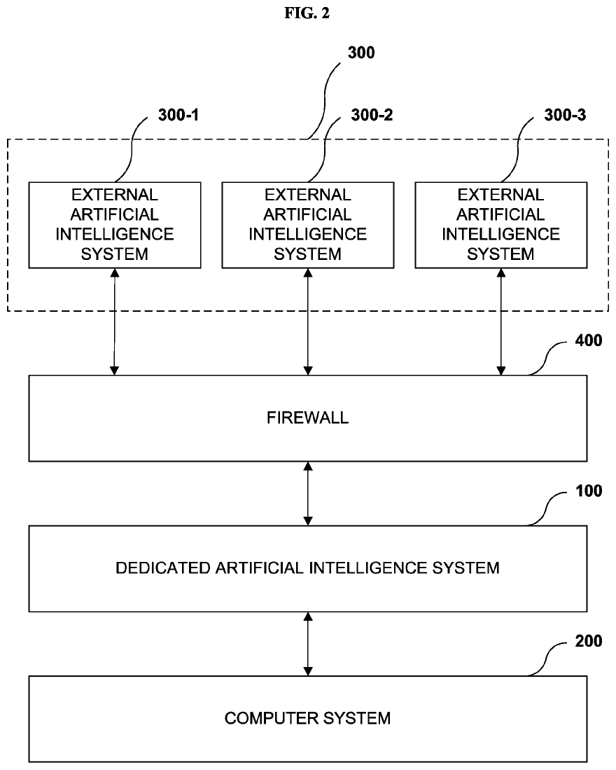

The communication interface 110 is configured to transmit and receive data through wired communication or wireless communication. Specifically, the communication interface 110 is configured to transmit and receive data, for example, between a computer system 200 to be described later and the dedicated artificial intelligence system 100 and between one or more external artificial intelligence systems 300 and the dedicated artificial intelligence system 100. In other words, the dedicated artificial intelligence system 100 may be connected to the computer system 200 (see FIG. 2) capable of performing an enterprise business (task) process through the communication interface 110. Further, the dedicated artificial intelligence system 100 may be directly or indirectly connected to one or more external artificial intelligences 300 (see FIG. 2) through the communication interface 110.

The communication interface 110 may be implemented by, for example, a semiconductor device such as a communication chip.

The operation processor 130 is connected to the communication interface 110. The operation processor 130 is configured to perform processes according to the technique described in the present disclosure, which will be described later. The operation processor 130 may be implemented by, for example, a semiconductor device (i.e., a processor) such as a central processing unit (CPU). Specifically, the operation processor 130 may include one or more processors 130-1 to 130-3 that are directly connected to each other or connected to each other through a communication network. Each of the one or more processors 130-1 to 130-3 is configured to perform at least a part of the processes to be described later performed by the operation processor 130. Although three processors 130-1 to 130-3 are shown in FIG. 1, the number of the processors of the first embodiment is not limited thereto. For example, the operation processor 130 may include one processor only or two processors, or may include four or more processors, if necessary.

The data repository 150 is configured to store artificial intelligence models and information related to the artificial intelligence models. The related information may include, for example, element information related to the artificial intelligence model, parameter data such as weight information, rule information, and history information. The data repository 150 may be implemented by, for example, a semiconductor device such as a semiconductor memory. The artificial intelligence model may include, for example, at least one of a restricted Boltzmann machine (RBM)/deep belief network (DBN) model, a recurrent neural network model, and a relation network (RL) model.

FIG. 2 is a diagram illustrating an exemplary configuration of a system environment including the dedicated artificial intelligence system according to the first embodiment of the present disclosure.

Referring to FIG. 2, the dedicated artificial intelligence system 100 is connected to the computer system (enterprise computer system) 200. The dedicated artificial intelligence system 100 and the computer system 200 are preferably connected through an enterprise network. Referring to FIG. 2, the dedicated artificial intelligence system 100 is connected to the one or more external artificial intelligence systems 300. The dedicated artificial intelligence system 100 and the one or more external artificial intelligence systems 300 may be connected through a network such as, for example, the Internet. The dedicated artificial intelligence system 100 and the one or more external artificial intelligence systems 300 are preferably connected through a security configuration such as a firewall 400.

The computer system 200 includes, for example, configurations that are used to perform and control the business processes within the enterprise (corporation) such as a customer relationship management system, a fraud detection system, and a factory management system. The computer system 200 performs the business processes mainly based on rules. Hereinafter, an example in which the fraud detection system is used as the computer system 200 will be described.

The one or more external artificial intelligence systems 300 are artificial intelligence systems (artificial intelligence platforms) provided outside the enterprise (corporation). For example, the external artificial intelligence system 300-1 may be an artificial intelligence system provided by Google. The external artificial intelligence system 300-2 may be an artificial intelligence system provided by Amazon. The external artificial intelligence system 300-3 may be an artificial intelligence system provided by Apple. Although three external artificial intelligence systems 300 are shown in FIG. 2, the number of the external artificial intelligence systems of the first embodiment is not limited thereto. For example, four or more external artificial intelligence systems may be used, if necessary.

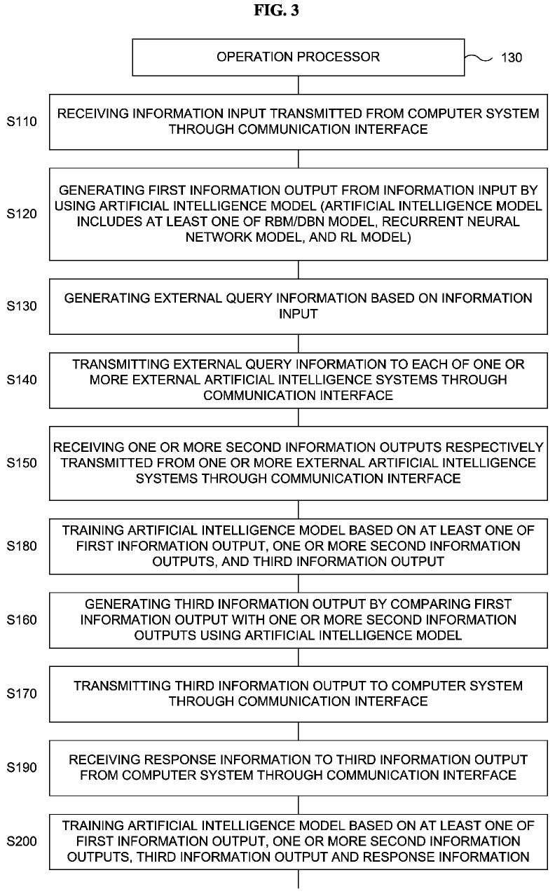

FIG. 3 is a diagram illustrating an example of processes performed by the operation processor of the dedicated artificial intelligence system according to the first embodiment.

First, the operation processor 130 performs a process S110 of receiving an information input transmitted from the computer system 200 through the communication interface 110.

The fraud detection system serving as the computer system 200 may transmit, for example, financial transaction request information to the dedicated artificial intelligence system 100 as the information input.

Next, the operation processor 130 performs a process S120 of generating a first information output from the information input by using an artificial intelligence model. As described above, the artificial intelligence model may include, for example, at least one of a RBM/DBN model, a recurrent neural network model, and an RL model.

In addition, algorithms such as a regression analysis algorithm, a clustering analysis algorithm, a k-nearest neighbor (KNN) algorithm, a naive bayes algorithm, a support vector machine (SVM) algorithm, principal component analysis (PCA) and density-based cluster analysis (DBSCAN) algorithms, a topic modeling algorithm, a genetic algorithm, an association rule analysis algorithm, a logistic regression analysis algorithm, and a time series analysis algorithm may be used to train the artificial intelligence model.

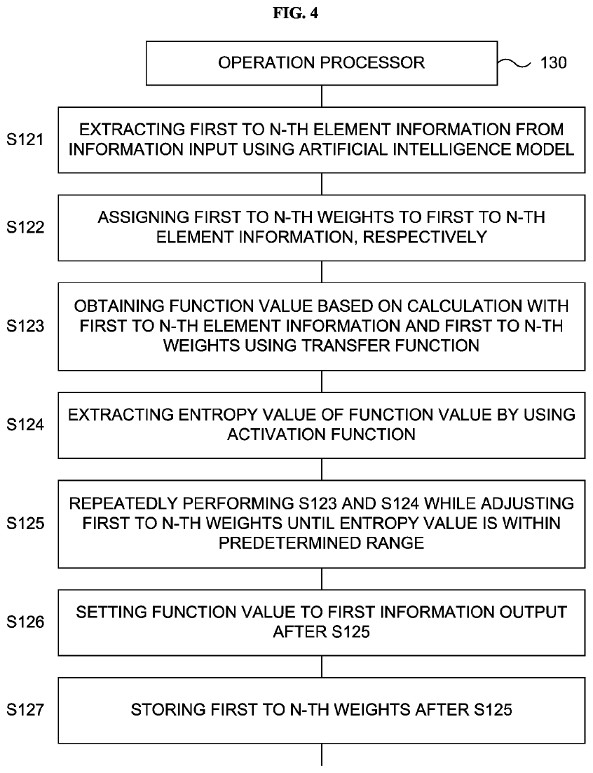

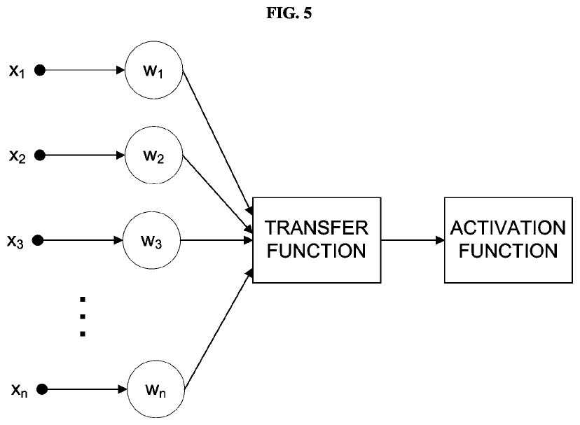

FIG. 4 is a diagram specifically illustrating the process of generating the first information output by the operation processor of the dedicated artificial intelligence system according to the first embodiment. FIG. 5 is a diagram specifically illustrating the process in which the operation processor of the dedicated artificial intelligence system according to the first embodiment generates the first information output.

First, the operation processor 130 performs a process S121 of extracting first to n-th element information (n is a natural number greater than or equal to 2) from the information input using the artificial intelligence model.

The first to n-th element information may be determined depending on a business (task) to be applied. For example, in a case where the information input is the financial transaction request information, the first to n-th element information (X₁ to Xₙ in FIG. 5) are generated based on the financial transaction request information, more preferably, the financial transaction request information and pre-stored history information.

For example, the first element information may be a calculated value for time information and place information of a financial transaction request. Further, for example, the second element information may be a calculated value for time information and amount information of the financial transaction request. Further, for example, the third element information may be a calculated value for log-in time information and log-out time information of the financial transaction request. N number of element information may be generated, and N may be appropriately determined using the artificial intelligence model.

Next, the operation processor 130 performs a process S122 of assigning first to n-th weights (W₁ to Wₙ in FIG. 5) to the first to n-th element information, respectively.

For example, the first weight is assigned to the first element information, and the n-th weight is assigned to the n-th element information. At the initial stage, the same value of the first to n-th weights may be assigned, but if the first to n-th weights are stored in advance, for example, if the first to n-th weights are stored in the data repository 150, the first to n-th weights stored in the data repository 150 may be used.

Next, the operation processor 130 performs a process S123 of obtaining a function value based on the calculation with the first to n-th element information and the first to n-th weights using a transfer function. For example, a function value may be obtained by summing up all the values obtained by multiplying the first to n-th element information by the first to n-th weights, respectively, and then averaging the sum of the obtained values.

Next, the operation processor 130 performs a process S124 of extracting an entropy value of the function value by using an activation function. The entropy value may be defined as the difference between the current function value and the previous function value extracted in the previous step (or a predetermined initial value).

Next, the operation processor 130 performs a process S125 of repeatedly performing processes S123 and S124 while adjusting the first to n-th weights until the entropy value falls within a predetermined range. For example, when the maximum value of the function value is 1, the predetermined range may be designated as a range of 0 to 0.01.

Next, the operation processor 130 performs a process S126 of setting the function value to the first information output after the completion of the process S125.

By performing the above processes, the first to n-th element information and the first to n-th weights may be determined through deep learning.

Referring to FIG. 4, the operation processor 130 may further perform a process S127 of storing the first to n-th weights after the completion of the process S125. For example, the operation processor 130 may store the first to n-th weights in the data repository 150. The operation processor 130 may store the first to n-th element information in the data repository 150.

Referring again to FIG. 3, the operation processor 130 performs a process S130 of generating external query information based on the information input.

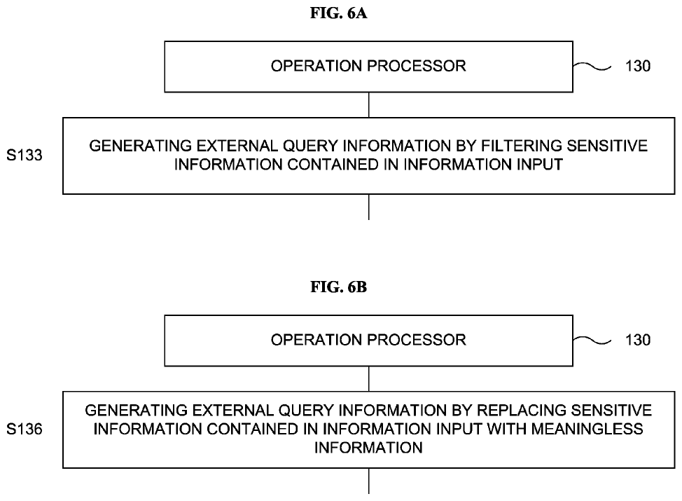

FIGS. 6A and 6B are diagrams specifically illustrating the process of generating the external query information by the operation processor of the dedicated artificial intelligence system according to the first embodiment.

Referring to FIG. 6A, the operation processor 130 may perform a process S133 of generating external query information by filtering out (i.e., removing) sensitive information contained in the information input. That is, in order to prevent the sensitive information such as company's trade secret information, customer's personal information, and device identification information from being exposed to the outside, the operation processor 130 generates the external query information by filtering out the sensitive information, for example, by deleting the sensitive information in the process S133.

Alternatively, referring to FIG. 6B, the operation processor 130 may include a process S136 of generating the external query information by replacing sensitive information contained in the information input with meaningless information. For example, the external query information may be generated in such a manner that the customer's user ID is replaced with the meaningless information such as “U11.”

Next, the operation processor 130 performs a process S140 of transmitting the external query information to each of the one or more external artificial intelligence systems 300 through the communication interface 110.

Next, the operation processor 130 performs a process S150 of receiving one or more second information outputs (which are generated by the one or more external artificial intelligence systems 300 based on the external query information) respectively transmitted from the one or more external artificial intelligence systems 300 through the communication interface 110.

Next, the operation processor 130 performs a process S160 of generating a third information output by comparing the first information output with the one or more second information outputs using the artificial intelligence model.

For example, if the information input is the financial transaction request information, the third information output contains information on a value for whether the financial transaction request information is fraud or not (abnormal or normal), a value for fraud type classification and related tags, a value for fraud symptoms, and a value for an expected response action. That is, for example, the third information output to be transmitted to the computer system 200 is generated based on the one or more second information outputs each having a function value similar to the first information output having a function value.

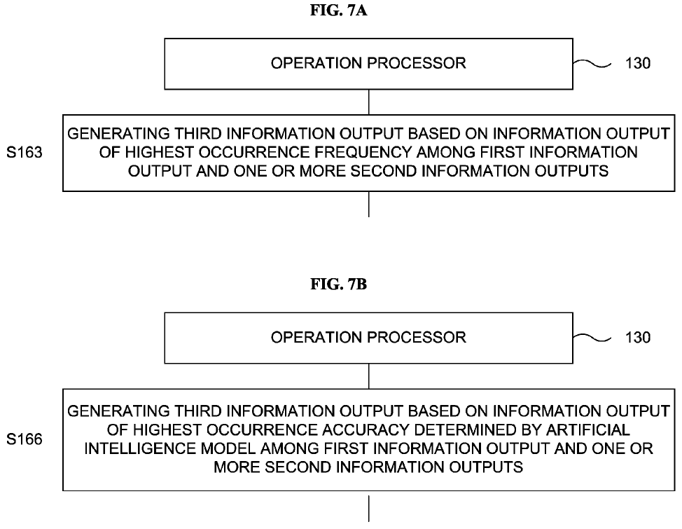

FIGS. 7A and 7B are diagrams specifically illustrating the process of generating the third information output by the operation processor of the dedicated artificial intelligence system according to the first embodiment.

Referring to FIG. 7A, the operation processor 130 may perform a process S163 of generating the third information output based on the most frequent information output among the first information output and the one or more second information outputs, wherein the occurrence frequency of the most frequent information output is the highest among the first information output and the one or more second information outputs. That is, the third information output may be generated based on the value of the information output of the highest occurrence frequency among the value of the first information output and the values of the one or more second information outputs. For example, when the performance of the dedicated artificial intelligence system 100 does not yet reach a certain level suitable for controlling the enterprise business (task) processes through artificial intelligence, or when the intelligence level of each of the dedicated artificial intelligence system 100 and the one or more external artificial intelligence systems 300 does not yet reach a certain level, the operation processor 130 may perform the process S163. The operation processor 130 is configured to generate the third information output based on the information output of the highest occurrence frequency among the first information output and the one or more second information outputs, that is, the information of the highest occurrence frequency of the same value or the similar values among all the information outputted through the dedicated artificial intelligence system 100 and the one or more external artificial intelligence systems 300.

The intelligence level of the artificial intelligence model of the dedicated artificial intelligence system 100 or the intelligence level of each of the artificial intelligence models of the one or more external artificial intelligence systems 300 may be evaluated, for example, based on a matching degree between a known result value and a result value calculated by the dedicated artificial intelligence system 100 (or result values calculated by the one or more external artificial intelligence systems 300).

Alternatively, the intelligence level of the artificial intelligence model may be evaluated using a receiver operating characteristic (ROC) curve. In general, it is determined that the narrower an area under the ROC curve (AUC) of the ROC curve, the higher the intelligence level of the artificial intelligence model.

Further, alternatively, referring to FIG. 7B, the operation processor 130 performs a process S166 of generating the third information output based on the most accurate information output among the first information output and the one or more second information outputs, wherein the most accurate information output is determined, by the artificial intelligence model, to be of the highest accuracy among the first information output and the one or more second information outputs. For example, when the performance of the dedicated artificial intelligence system 100 reaches a certain level or higher suitable for controlling the enterprise business (task) processes through artificial intelligence, the operation processor 130 may perform the process S166. The accuracy is determined by the artificial intelligence model and may be updated as the learning of the artificial intelligence model progresses.

Referring back to FIG. 3, the operation processor 130 performs a process S170 of transmitting the third information output to the computer system 200 through the communication interface 110.

Referring back to FIG. 3, the operation processor 130 may further perform a process S180 of training the artificial intelligence model based on at least one of the first information output, the one or more second information outputs, and the third information output. That is, the operation processor 130 may train the artificial intelligence model by using various pieces of information such as the first information output, the one or more second information outputs, and the third information output. Through the process S180, a learning level of the artificial intelligence model of the dedicated artificial intelligence system 100 can be rapidly improved. That is, it is possible to increase the learning speed of the artificial intelligence model of the dedicated artificial intelligence system 100.

Referring to FIG. 3, the operation processor 130 may further perform a process S190 of receiving response information to the third information output from the computer system 200 through the communication interface 110 and a process S200 of training the artificial intelligence model based on at least one of the first information output, the one or more second information outputs, the third information output and the response information.

When the operation processor 130 receives the response information, it may check whether the determination based on the third information output is correct. For example, in the case where the information input is the financial transaction request information, even when the operation processor 130 transmits the third information output indicating the determination that the financial transaction request information is normal to the computer system 200, the actual result of the actual financial transaction or the actual determination of a person in charge of business (task) may be abnormal.

Since the operation processor 130 performs the process S200 of training the artificial intelligence model by reflecting such an actual response information, the learning level of the artificial intelligence model of the dedicated artificial intelligence system 100 can be rapidly improved. In addition, the response information is provided only to the dedicated artificial intelligence system 100 and is not provided to the one or more external artificial intelligence systems 300. Accordingly, the learning level of the artificial intelligence model of the dedicated artificial intelligence system 100 may be improved more rapidly compared to the learning level of each of the artificial intelligence models of the one or more external artificial intelligence systems 300. In other words, the learning speed of the artificial intelligence model of the dedicated artificial intelligence system 100 can be higher than the learning speed of the one or more external artificial intelligence systems 300.

### Second Embodiment

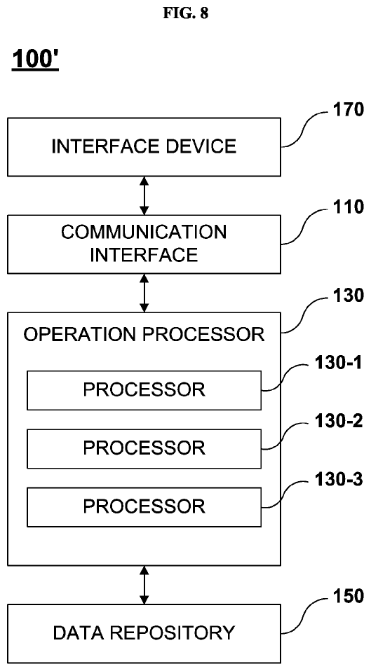

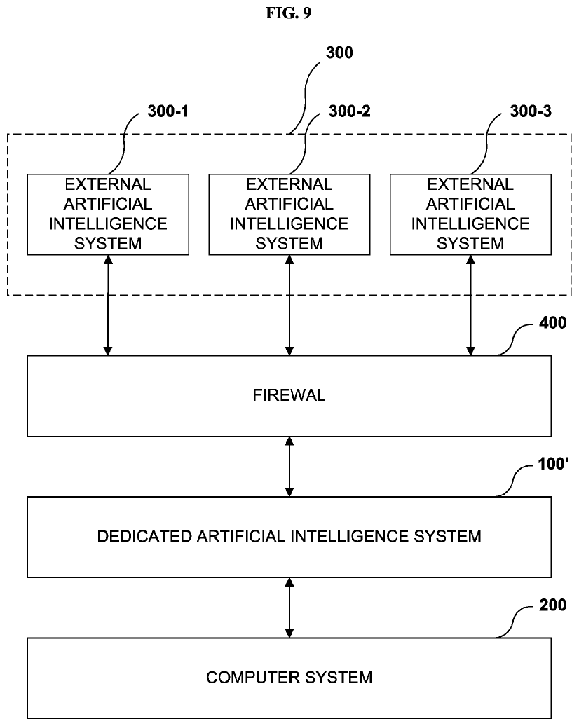

FIG. 8 is a diagram illustrating an exemplary configuration of a dedicated artificial intelligence system according to a second embodiment of the present disclosure, and FIG. 9 is a diagram illustrating an exemplary configuration of a system environment including the dedicated artificial intelligence system according to the second embodiment of the present disclosure. Hereinafter, like reference numerals will be given to like parts, and the difference between the second embodiment and the first embodiment will be mainly described.

Referring to FIGS. 8 and 9, the dedicated artificial intelligence system 100′ according to the second embodiment is different from the dedicated artificial intelligence system 100 according to the first embodiment in that the dedicated artificial intelligence system 100′ according to the second embodiment further includes an interface device 170. The interface device 170 is connected to a communication interface 110. The interface device 170 may be implemented by, for example, a computing device including a communication chip, a memory and a CPU.

In the dedicated artificial intelligence system 100′ according to the second embodiment, the operation processor 130 is connected to the one or more external artificial intelligence systems 300 through the communication interface 110 and the interface device 170. It is preferable that the dedicated artificial intelligence system 100′ and the one or more external artificial intelligence systems 300 are connected through a security configuration such as the firewall 400 in the same manner described in the first embodiment.

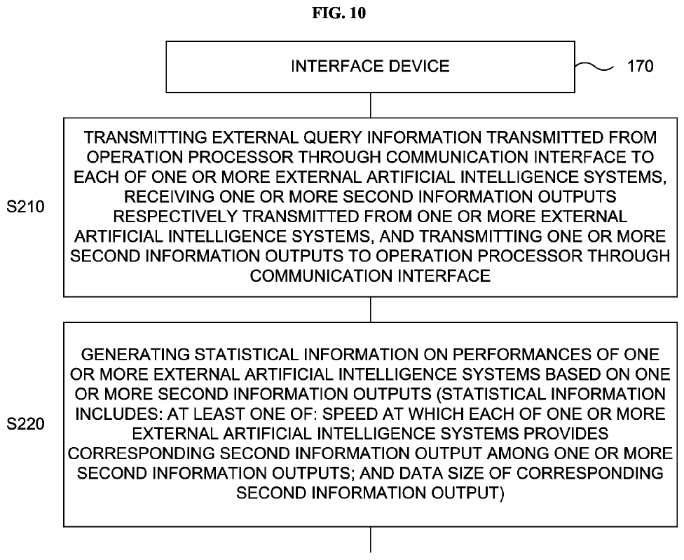

FIG. 10 is a diagram illustrating an example of processes performed by the interface device according to the second embodiment of the present disclosure.

Referring to FIG. 10, the interface device 170 performs a process S210 of transmitting external query information transmitted from the operation processor 130 through the communication interface 110 to each of the one or more external artificial intelligence systems 300, receiving one or more second information outputs respectively transmitted from the one or more external artificial intelligence systems 300, and transmitting the one or more second information outputs to the operation processor 130 through the communication interface 110.

By providing the interface device 170, the dedicated artificial intelligence system 100′ and the one or more external artificial intelligence systems 300 are indirectly connected. Accordingly, the exposure probability of sensitive information from the dedicated artificial intelligence system 100′ can be further reduced. Preferably, the interface device 170 may also be connected to the one or more external artificial intelligence systems 300 through the firewall 400.

Referring to FIG. 10, the interface device 170 may perform a process S220 of generating statistical information on the performances of the one or more external artificial intelligence systems 300 based on the one or more second information outputs. The statistical information may include at least one of a speed at which each of the one or more external artificial intelligence systems 300 provides the corresponding second information output among the one or more second information outputs and a data size of the corresponding second information output among the one or more second information outputs. As described above, since the interface device 170 may be implemented by the computing device, the interface device 170 may be configured to perform the process S220 of generating the statistical information on the performances of the one or more external artificial intelligence systems 300 based on the one or more second information outputs. Based on the statistical information generated by the interface device 170, the dedicated artificial intelligence system 100′ may evaluate each of the one or more external artificial intelligence systems 300.

### Other Embodiments

Although the embodiments of the technique described in the present disclosure have been described in detail, the presently disclosed embodiments are considered in all respects to be illustrative and not restrictive. Further, for those of ordinary skill in the art to which the technique described in the present disclosure pertains, the above-described embodiments may be omitted, replaced, or changed in various forms without departing from the scope of the technique described in the present disclosure.

Accordingly, the exemplary embodiments disclosed herein are not used to limit the technical idea of the present disclosure, but to explain the present disclosure, and the scope of the technical idea of the present disclosure is not limited by those embodiments. Therefore, the scope of protection of the present disclosure should be construed as defined in the following claims, and all technical ideas that fall within the technical idea of the present disclosure are intended to be embraced by the scope of the claims of the present disclosure.

According to the technique described in the present disclosure, it is possible to provide a dedicated artificial intelligence system capable of increasing a learning speed by using information output of an external artificial intelligence system(s) while enhancing security.

What is claimed is:

1. A dedicated artificial intelligence system connected to a computer system that performs enterprise business processes, the dedicated artificial intelligence system comprising:
a communication interface; and
an operation processor connected to the communication interface,
wherein the operation processor performs:
(a) receiving an information input transmitted from the computer system through the communication interface;
(b) generating a first information output from the information input by using an artificial intelligence model;
(c) generating external query information based on the information input;
(d) transmitting the external query information to each of one or more external artificial intelligence systems through the communication interface;
(e) receiving one or more second information outputs respectively transmitted from the one or more external artificial intelligence systems through the communication interface;
(f) generating a third information output by comparing the first information output and the one or more second information outputs using the artificial intelligence model; and
(g) transmitting the third information output to the computer system through the communication interface.

2. The dedicated artificial intelligence system of claim 1, wherein the operation processor further performs (h) training the artificial intelligence model based on at least one of the first information output, the one or more second information outputs, and the third information output.

3. The dedicated artificial intelligence system of claim 1, wherein the operation processor further performs:
(i) receiving response information to the third information output from the computer system through the communication interface; and
(j) training the artificial intelligence model based on at least one of the first information output, the one or more second information outputs, the third information output, and the response information.

4. The dedicated artificial intelligence system of claim 1, wherein (b) includes:
(b-1) extracting first to n-th element information (n is a natural number greater than or equal to 2) from the information input using the artificial intelligence model;
(b-2) assigning first to n-th weights to the first to n-th element information, respectively;
(b-3) obtaining a function value based on a calculation with the first to n-th element information and the first to n-th weights using a transfer function;
(b-4) extracting an entropy value of the function value using an activation function;
(b-5) repeatedly performing (b-3) and (b-4) while adjusting the first to n-th weights until the entropy value falls within a predetermined range; and
(b-6) setting the function value to the first information output after completion of (b-5).

5. The dedicated artificial intelligence system of claim 4, wherein (b) further includes (b-7) storing the first to n-th weights after the completion of (b-5).

6. The dedicated artificial intelligence system of claim 1, wherein (c) includes (c-1) generating the external query information by filtering out sensitive information contained in the information input.

7. The dedicated artificial intelligence system of claim 1, wherein (c) includes (c-2) generating the external query information by replacing sensitive information contained in the information input with meaningless information.

8. The dedicated artificial intelligence system of claim 1, wherein (f) includes (f-1) generating the third information output based on a most frequent information output among the first information output and the one or more second information outputs, wherein an occurrence frequency of the most frequent information output is highest among the first information output and the one or more second information outputs.

9. The dedicated artificial intelligence system of claim 1, wherein (f) includes (f-2) generating the third information output based on a most accurate information output among the first information output and the one or more second information outputs, wherein the most accurate information output is determined, by the artificial intelligence model, to be of highest accuracy among the first information output and the one or more second information outputs.

10. The dedicated artificial intelligence system of claim 1, wherein the operation processor includes one or more processors that are directly connected to each other or connected through a communication network.

11. The dedicated artificial intelligence system of claim 1, further comprising a data repository that stores the artificial intelligence model.

12. The dedicated artificial intelligence system of claim 1, further comprising an interface device connected to the communication interface, the interface device being configured to transmit the external query information transmitted from the operation processor through the communication interface to each of the one or more external artificial intelligence systems, receive the one or more second information outputs respectively transmitted from the one or more external artificial intelligence systems, and transmit the one or more second information outputs to the operation processor through the communication interface.

13. The dedicated artificial intelligence system of claim 12, wherein the interface device is further configured to generate statistical information on performances of the one or more external artificial intelligence systems based on the one or more second information outputs.

14. The dedicated artificial intelligence system of claim 13, wherein the statistical information includes at least one among: a speed at which each of the one or more external artificial intelligence systems provides a corresponding second information output among the one or more second information outputs; and a data size of the corresponding second information output.

15. The dedicated artificial intelligence system of claim 12, wherein the interface device is connected to the one or more external artificial intelligence systems through a firewall.
